(19) United States
(12) Patent Application Publication
(10) Pub. No.: US 2009/0260088 A1
(43) Pub. Date: Oct. 15, 2009

(54) System and Method for Data Destruction

(76) Inventor: Robert Chi-Thanh Quach, Scarborough (CA)

Correspondence Address: Maier & Maier, 1000 Duke Street, Alexandria, VA, 22314, US

(21) Appl. No.: 12/084,384

(22) PCT Filed: Jan. 18, 2007
(86) PCT No.: PCT/IB2007/002071

§ 371 Date: Apr. 30, 2008

Related U.S. Application Data
(60) Provisional application No. 60/761,355, filed on Jan. 24, 2006.

(51) Int. Cl. G06F 21/00; G06F 17/30

(52) U.S. Cl. 726/26; 707/10

(57) ABSTRACT

A system and method for self-activated or remote-controlled data destruction for mobile devices. In an embodiment, when the user is unable to find their mobile device, they can log onto a web-base/software application through the computer or other communication device such as a telephone or mobile devices to request a data destruction command to be sent to the lost mobile device. If the lost mobile device, after a specified time duration, does not have any reception to receive any signals nor has any battery-power, the self-destruction application embedded in the mobile device will automatically activate itself during the next reset procedure or power up or shut down process. This application will perform a memory erase procedure for all selected data on the mobile device. To increase the area of service the embedded application can scan and connect to other available networks such as Wi-Fi to extend the coverage area.

### CLAIM OF PRIORITY

This patent application claims priority from provisional patent application, Ser. No. 60/761,355, filed on Jan. 24, 2006.

### BACKGROUND

Mobile devices such as cell phones, smart phones, PDAs and laptops are becoming more advanced and portable. These mobile devices are capable of running more powerful software and applications thus the content being stored on them has become increasingly important. As more consumers and businesses rely on mobile devices for storage of sensitive information, protection and security of stored data becomes a high priority especially when the mobile device can be easily lost or stolen.

Therefore the inventors believe there are needs that have not been met by existing systems. For example, some users have a need to minimize unauthorized access to mobile data. Also, there is a need to prevent any access to the data when the user does not have physical access to the mobile device, for example when it is stolen. Furthermore, it would be desirable to have a way to erase data when a mobile device is located in a no reception area or when the battery is dead.

### SUMMARY OF THE INVENTION

In the preferred embodiment, a registered user loses his/her mobile device. A person finds the device, but it is locked by the program. The person enters a few credential and fails. After a pre-defined number of attempts, the program goes into lock down mode.

All data are erased on the device and it powers itself down. When device is powered up again, the program will load and prompts for user credential.

Another possible example to protect the data if/when a thief steals the mobile device from the registered user. The thief immediately powers down the device. At a later time, the thief powers up the device. The device immediately loads the program and prompts the user for credential; at high security setting, the program removes all user data upon powering-on to ensure maximum protection. The thief enters a few credentials and fails. After a predefined number of attempts, the program goes into lock down mode. All data are erased on the device and it powers itself down.

Another possible example is when the user loses his/her mobile device. The user contacts the company's call centre (or the user can logon to the company's user website, authenticates his/herself and initiate the destruction command on the missing device without contacting the company's call centre). The user authenticates his/herself with the customer service representative. The customer service representative initiated a data destruction command to the missing device. The company's “data destruction” server sends the data destruction command to the missing device via SMS gateway; the “data destruction” server can contact the missing device via other mechanisms such as TCP/IP network. The “data destruction” server will continues to send the data destruction command to the missing device until a confirmation is received. The missing device receives the command, executes the data destruction command by removing all data and confirms the command with the ““data destruction”” server. The customer service rep sees that the kill command has been successfully executed by the missing device and notifies the user.

Another possible example: The user finds back the misplaced device and it had already gone under a data erase procedure. Upon the powering on of the device, the user is prompted to enter his/her credential. The credentials are authenticated with the company server. After the successful authentication, the program restores the device by starting a synchronization session with the sync server. After the synchronization is completed, the device is back to its original state with the latest user data.

### BRIEF DESCRIPTION OF DRAWINGS

FIG. 1: Block diagram of a typical communication system for data destruction system.

FIG. 2: Flowchart for network signal detection and connection

FIG. 3: Flowchart for data erase on system startup

FIG. 4: Flowchart for remote data erase on demand

FIG. 5: Flowchart for authorization of the user

### DETAILED DESCRIPTION OF PREFERRED EMBODIMENTS OF THE INVENTION

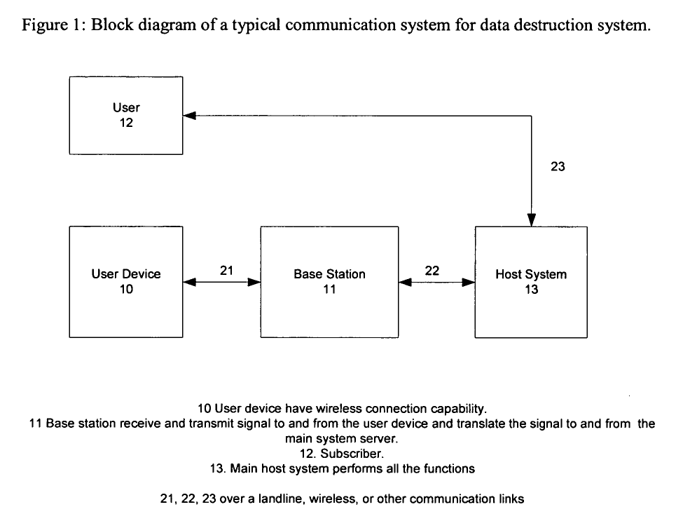

As shown in FIG. 1, a block diagram of an exemplary embodiment of a data destruction system. In an embodiment, the data destruction system comprises a three-tier information system. The three-tier information system comprises database server(s) and an application server(s) (13) and distributed terminal workstations (10). Each terminal workstation (10) may be, for example, a mobile computing device, which may be but is not limited to a personal digital assistant (PDA), a laptop computer, or a smart phone. The system may contain at least one application server. Each application server comprises core and business logic of the communication system, including database management. The application server (13) processes what is input by users, and returns results of processing to users. The database server controls processing of data stored in a database located in the database server (13). Such processing includes reading, writing, deleting, modifying, and backup.

In some embodiments, a communication base (11) provides a communication path (21) to each mobile computing device. The mobile computing device communicates with the communication base. The communication base (11) is also connected to the application servers (13) through a communication path (22). The communication path (22) may be either private or public. In addition, the communication path may or may not be wireless; that is, employ wireless communication. In the preferred embodiment, each application server (13) may be coupled to a local area network (LAN), which itself also connects to the database server. The LAN provides access to the Internet for the application servers and the computing devices. In the alternate embodiment, the mobile device therefore also has access to the Internet via the LAN, to any of the application servers, thru the communication path 21, and to the communication path 22.

In an alternate embodiment, communication system could be used between the mobile computing device (10) and the base station (11). The alternative communication system is similar to the above-described typical communication system. However, in the alternative communication system, the mobile computing device is connected to the base station (11) using but not limited to an Ethernet card, a phone line, a coaxial cable, an electric wire or a combination of any of the above media. Through the LAN, the mobile computing device can access the application and database server (13).

The above-described typical and alternative communication systems are used as examples only. Many variations of the systems described, and even different types of systems, can also be employed to incorporate the data destruction system and to practice the present invention. For example, the system and methods disclosed herein can be employed in a LAN-based data server configuration. It should also be apparent to one with skill in the art that the disclosed method can be advantageously deployed within almost any communication or other type of system in which either bandwidth and/or device memory is an issue. Furthermore, the claimed subject matter is not limited to systems that employ wireless communication links. Nevertheless, this is one area in which the advantages of the claimed subject matter are readily apparent. The software applications may be programmed by persons commonly skilled in the art.

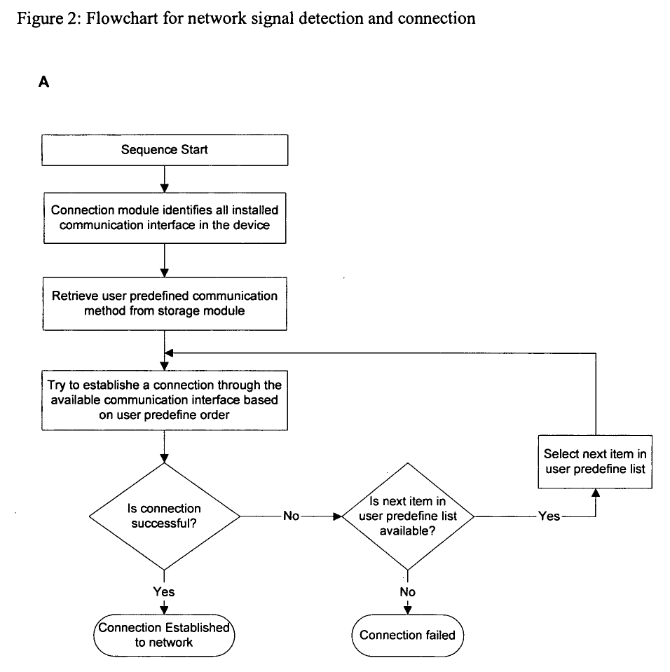

FIG. 2 is a flowchart of an exemplary embodiment of a method for detecting and connecting to a preferred available network. A user predefines his preference for network connection methods. The connection module will check for available connection interfaces in the device. Based on the user's predefined preferred communication method list, device will search for available network signals in the surrounding area. A connection module may be used to select the type of connection method based on user's pre-defined preferences or default settings.

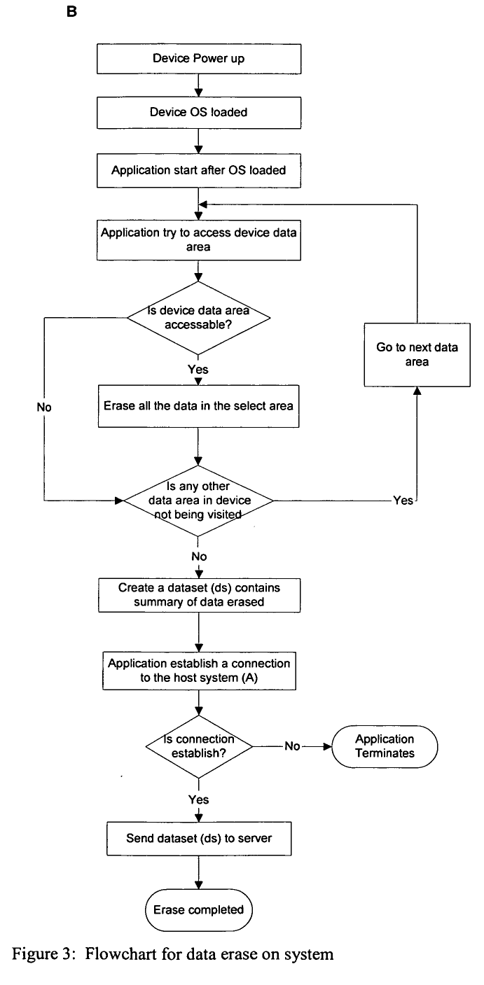

FIG. 3 is a flowchart showing an exemplary embodiment of a data erasing procedure on system startup. Each time a device equipped with this procedure is powered on, the device's operating system is first loaded. Next the “Data-Erase” application is loaded into the mobile system and executed. The application then initiates a search for the data to erase. If the requested data is present, then said data is erased from memory. This process of searching for the data requested to be erased and erasing from memory repeats until all data that is to be erased has been erased. The application may generate a summary detailing what data has been successfully erased from memory. This summary may then be uploaded to the host server through an established connection between the mobile device and the host server.

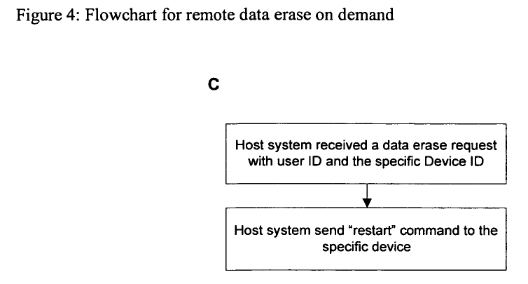

FIG. 4 is a flowchart showing an exemplary embodiment of a method for remote data erasure on demand. When user initiates a request to erase data on a specific registered mobile device, the host server sends a data-destruction signal to the mobile device. Once the mobile device receives this signal, it will automatically force the system to restart. This will then begin a data erase process, for example, the process discussed above with reference to FIG. 3.

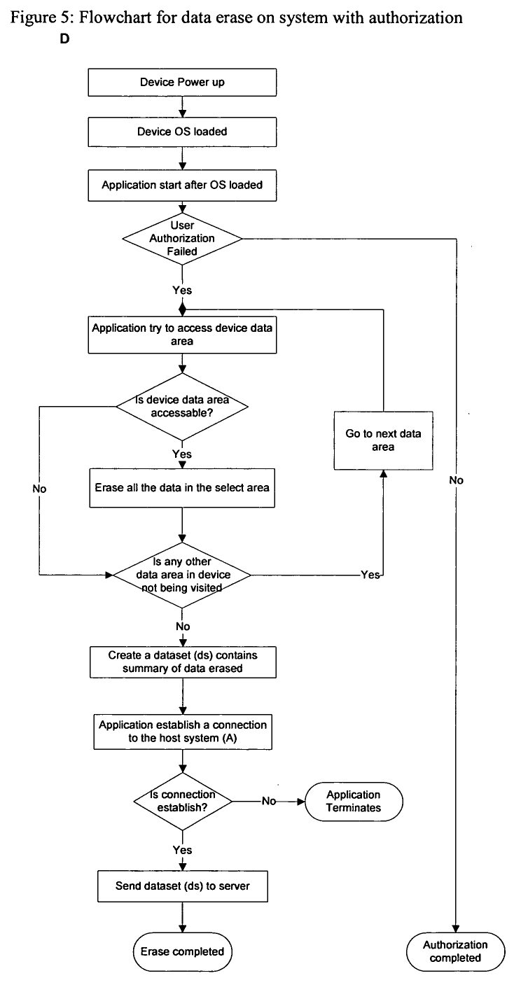

FIG. 5 is with reference to FIG. 3 with an authorization step after Application start after OS loaded. This is a user option in which credential is prompted and verified before deletion process occurs.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below

We claim:

1. A method for initiation of data destruction on remote device(s) comprising:
a. Initiating a destruction command;
b. Transmitting data destruction command to device; and
c. Deleting predetermined data contained within the device.

2. A method as in claim 1 whereas, said remote device is a laptop, PDA, external memory device or cellular phone.

3. A method as in claim 2 whereas, said remote device may be combined.

4. A method as in claim 3 whereas, said data destruction transmission is achieved through a network.

5. A method as in claim 3 whereas, said data destruction transmission is achieved through the internet.

6. A method as in claim 3 whereas, said data destruction transmission is achieved through a wireless transmission.

7. A method as in claim 3 whereas, said data destruction transmission is received and commenced regardless of the state of the powered device.

8. A method as in claim 3 whereas, backup data is automatically transmitted prior to data destruction.

9. A method for initiation of data destruction on remote devices comprising:
a. Auto-Initiating a destruction command based on user predetermined settings; and
b. Deleting predetermined data contained within the device.

10. A method as in claim 9 whereas, said predetermined setting is triggered when a known unauthorized use of the device.

11. A method as in claim 9 whereas, said predetermined setting is triggered when a user predetermined period of non-use has lapsed.

12. A method as in claim 9 whereas, backup data is automatically transmitted prior to data destruction.

13. A method for initiation of data destruction on remote device(s) comprising:
a. Initiating a destruction command by entering an incorrect password;
b. Transmitting a copy of said data to a remote storage device; and
c. Deleting predetermined data contained within the device.

14. A method for secure data on remote device(s) comprising:
a. Logging onto said device(s) with a secure security key;
b. Transferring all user predefined data which once resided on the device prior to logging off onto said device; and
c. Transferring and deleting all user predefined data upon user logging off.

15. An apparatus for data destruction on remote device(s) comprising:
a. one or more remote device(s) storing user data connecting to a centralized data processing subsystem;
b. at least one application server or processing, sending, receiving, verifying and storing the data and at least one database server for storing of the data;
c. at least one communication network for the transmission of the transaction data within and between said one or more data remote device and said at least one application server, with at least one database server;
d. said application server sends a destruction command to the remote device(s); and
e. predetermined data residing on the remote device is deleted.

16. An apparatus as in claim 15 whereas, said remote device is a laptop, PDA, external memory device, or cellular phone.

17. An apparatus as in claim 15 whereas, said remote device may be combined.

18. An apparatus as in claim 15 whereas, said data destruction transmission is achieved through a network.

19. An apparatus as in claim 15 whereas, said data destruction transmission is achieved through the internet.

20. An apparatus as in claim 15 whereas, said data destruction transmission is achieved through a wireless transmission.

21. An apparatus as in claim 15 whereas, said data destruction transmission is received and commenced regardless of the state of the powered device.

22. An apparatus as in claim 15 whereas, backup data is automatically transmitted prior to data destruction.

23. An apparatus for data destruction on remote device(s) comprising:
a. one or more remote device(s) storing user data connecting to a centralized data processing subsystem;
b. at least one application server or processing, sending, receiving, verifying and storing the data and at least one database server for storing of the data;
c. at least one communication network for the transmission of the transaction data within and between said one or more data remote device and said at least one application server, with at least one database server;
d. said application server sends a destruction command to the remote device(s) upon instruction from the user; and
e. predetermined data residing on the remote device is deleted.

24. An apparatus for data destruction on remote device(s) comprising:
a. one or more remote device(s) storing user data connecting to a centralized data processing subsystem;
b. at least one application server or processing, sending, receiving, verifying and storing the data and at least one database server for storing of the data;
c. at least one communication network for the transmission of the transaction data within and between said one or more data remote device and said at least one application server, with at least one database server;
d. said application server sends a destruction command to the remote device(s) which is auto-initiating based upon user predetermined settings; and
e. predetermined data residing on the remote device is deleted.

25. An apparatus as in claim 24 whereas, said predetermined setting is triggered when a known unauthorized use of the device.

26. An apparatus as in claim 24 whereas, said predetermined setting is triggered when a user predetermined period of non-use has lapsed.

27. An apparatus as in claim 24 whereas, backup data is automatically transmitted prior to data destruction.

28. An apparatus for data destruction on remote device(s) comprising:
a. one or more remote device(s) storing user data connecting to a centralized data processing subsystem;
b. at least one application server or processing, sending, receiving, verifying and storing the data and at least one database server for storing of the data;
c. at least one communication network for the transmission of the transaction data within and between said one or more data remote device and said at least one application server, with at least one database server;
d. said application server sends a destruction command to the remote device(s) which upon entering an incorrect password; and
e. predetermined data residing on the remote device is deleted.

29. An apparatus for data destruction on remote device(s) comprising:
a. one or more remote device(s) storing user data connecting to a centralized data processing subsystem;
b. at least one application server or processing, sending, receiving, verifying and storing the data and at least one database server for storing of the data;
c. at least one communication network for the transmission of the transaction data within and between said one or more data remote device and said at least one application server, with at least one database server;
d. a user securely logs into said remote device(s);
e. said application server sends all data to the remote device(s); and
f. data residing on the remote device is transmitted to the application server and deleted from the device upon said user logging off.
